(19) United States
(12) Patent Application Publication
(10) Pub. No.: US 2003/0047659 A1
(43) Pub. Date: Mar. 13, 2003

(54) Article foldable into an easel

(76) Inventor: David E. Evans, Cape Neddick, ME (US)

Correspondence Address: FISH & RICHARDSON P.C., 3300 DAIN RASCHER PLAZA, 60 SOUTH SIXTH STREET, MINNEAPOLIS, MN, 55402, US

(21) Appl. No.: 09/952,712

(22) Filed: Sep. 12, 2001

(51) Int. Cl. F16M 11/00

(52) U.S. Cl. 248/459; 248/174

(57) ABSTRACT

An article that can be folded into an easel. In an illustrative embodiment, the article comprises a sheet with a display section and first, second and third foldable panel sections. The display section and the panel sections each comprise opposing first and second faces. The article can be arranged as an easel by folding the first, second and third panel sections such that the first face of the third section abuts the second face of the display section. In another illustrative embodiment, the article comprises a panel with a display portion and an easel portion, where the display portion and the easel portion are divided by a boundary. The easel portion is in part defined by a terminal edge, and the article can be arranged as an easel by attaching part of the easel portion to the display portion with the terminal edge at the boundary.

### BACKGROUND

This invention relates to an article foldable into an easel, and more particularly to a sheet structure that can be folded into an easel for displaying a photograph, illustration, or other element.

Photographs and the like are commonly sent through the mail. However, after receipt a photograph by itself can only be displayed in limit number of ways. It is possible to affix the photograph to a wall or note board, with the disadvantage that it is somewhat inconvenient to relocate the photo, and the location can not be optimal for viewing the photograph. It is also possible to simply rest the photo against an object on a tabletop or on a shelf, with the disadvantage that it can not sit at a proper angle for viewing and that it easily falls over.

Auxiliary means can be provided for placing the photo in an improved or optimal viewing position, such as a frame or easel. However, due to the relatively high cost of frames and easels, few photographs sent via mail are ultimately placed in a permanent viewable position.

A disproportionate number photographs sent though the mail are placed into storage due in substantial part to the absence of a suitable display element, such as a frame or easel. It is accordingly desirable to provide recipients of photographs and the like with a cost effective means to display the same.

The foregoing problems are by no means limited to the display and viewing of photographs. Articles of various other constructions are received but not often kept in a viewable environment due to the absence of a suitable display element. Examples include calendars, liquid crystal display devices, light emitting diode devices, and promotional items.

### SUMMARY

The invention is directed to an article that can be folded into an easel useful for displaying a photograph, illustration, or other element. In an illustrative embodiment, the article comprises a sheet with a display section and first, second and third foldable panel sections. The display section and the panel sections each comprise opposing first and second faces. The article can be arranged as an easel by folding the first, second and third panel sections such that the first face of the third section abuts the second face of the display section. In another exemplary embodiment, the article comprises a panel with a display portion and an easel portion, wherein the display portion and the easel portion are divided by a score line. The easel portion terminates at an edge, and the article can be arranged as an easel by folding the easel portion such that its terminal edge abuts the score line. In other embodiments, the display element is a mailable article wherein an address portion is included on the rear face of the article and the easel portion can be folded over the photograph or other displayed element to protect it during mailing.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a plan view of a display element of the instant invention;

FIG. 2 is a plan view of an opposite side of the element shown in FIG. 1;

FIG. 3 is a side view illustrating the embodiment in FIG. 1 folded into an easel; and

FIG. 4 is a perspective view of the embodiment in FIG. 3.

Like reference symbols in the various drawings indicate like elements.

### DETAILED DESCRIPTION OF ILLUSTRATIVE EMBODIMENTS

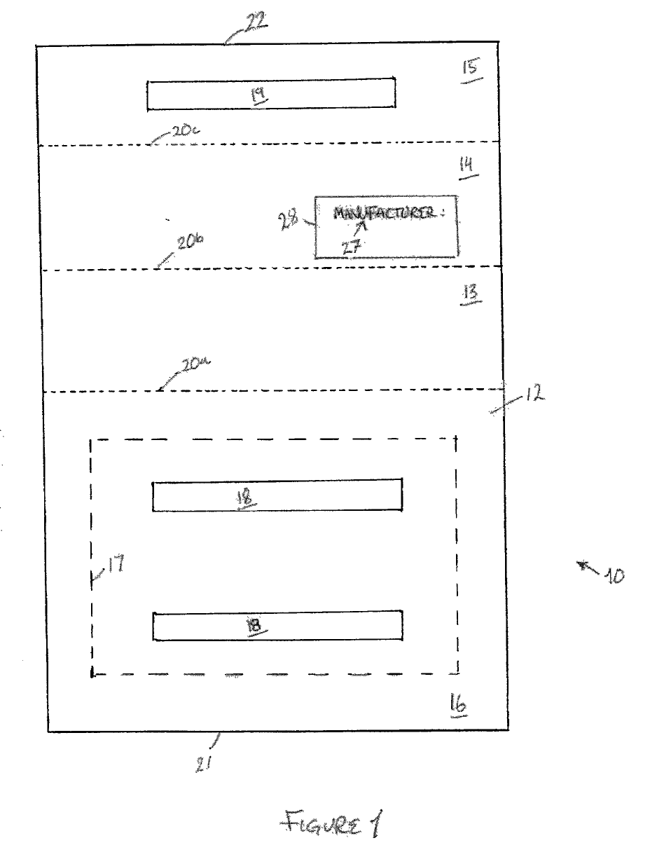

FIG. 1 schematically illustrates a display element 10 that is an embodiment of the invention. A sheet 12 is of generally rectangular shape, and can be folded into a photo display as will be described below. The sheet 12 can be manufactured from any suitable material; for example, it can be manufactured from paper stock, such as that sold under the name “#7 Bristol Note.” The size and shape of sheet 12 can be chosen in consideration of the particular application, and no particular shape or size is required. For example, the sheet 12 can be approximately 11.25 by 7.5 inches. The sheet 12 is divided into easel or panel sections 13, 14 and 15, and display section 16. The panel sections 13-15 will be further described below. The display section 16 can display a photo or other illustration 17 (shown in phantom). The photo or other illustration can be provided on the display section 16 in any suitable way. For example, the display section 16 can comprise one or more fasteners 18 for securing the photo 17. The fasteners 18 can comprise any fastener or adhesive for securing the photo 17 to the display section 16. In some applications, the fastener 18 can releasably attach the photo 17 to the display section 16. The configuration, shape and strength of the fastener 18 is selected based upon the particular application. Preferably, fastener 18 is an adhesive with a releasable seal film.

The first panel section 13 can be located adjacent the display section 16. The second panel section 14 can be located adjacent panel section 13, on the opposite side from the display section 16. The third panel section 15 can be located adjacent the second panel section 14, on the opposite side from the first panel section 13. The third panel section 15 can be smaller than the first and second panel sections 13 and 14. The first panel section 13 can be of the same size as the second panel section 14.

The first, second and third panel sections 13-15 and the display section 16 can be separated, respectively, by boundaries 20a, 20b and 20c, as shown. The boundaries 20a-c are illustrated to clarify the explanation of how the article 10 is used to form an easel; there need not be any physical structure or feature corresponding to any or all of the boundaries 20a-c in a given application. To simplify assembly of the easel from the article 10 in some applications, however, one or more of the boundaries 20a-c can comprise a physical feature that facilitates folding of the sheet 12. For example, one or more of the boundaries 20a-c can comprise a score, perforation, pre-fold or other weakening in the sheet 12. In the illustrated embodiment, sheet 12 comprises edge 22 adjacent the third panel section 15.

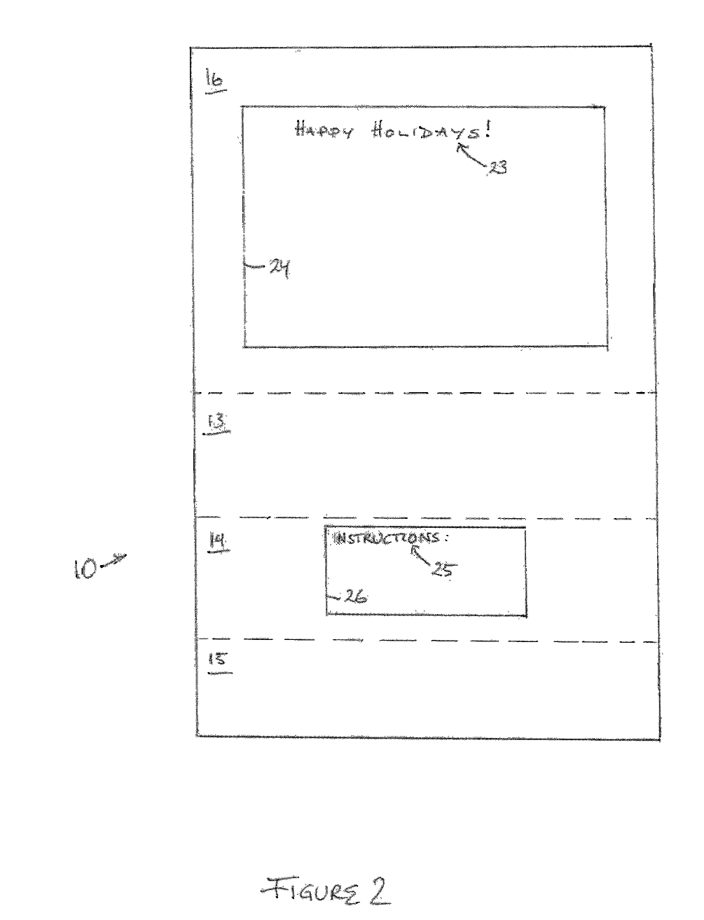

FIG. 2 illustrates an opposite side of the embodiment in FIG. 1 wherein sheet 12 is folded to form an easel. The steps need not be performed in the order described. The first panel section 13 is folded relative to display section 16 toward a reverse portion of the display section 16 (and consequently, in the shown embodiment, so are sections 14 and 15). The second panel section 14 is folded with regard to the first panel section 13 toward the back surface of the display section 16. The third panel section 15 is folded with regard to the second panel section 14, such that the face of the third panel section 15 is essentially parallel to, and abuts, the back surface of the display section 16. When the easel is complete, it can rest upon the first panel section 13 while standing in its intended position.

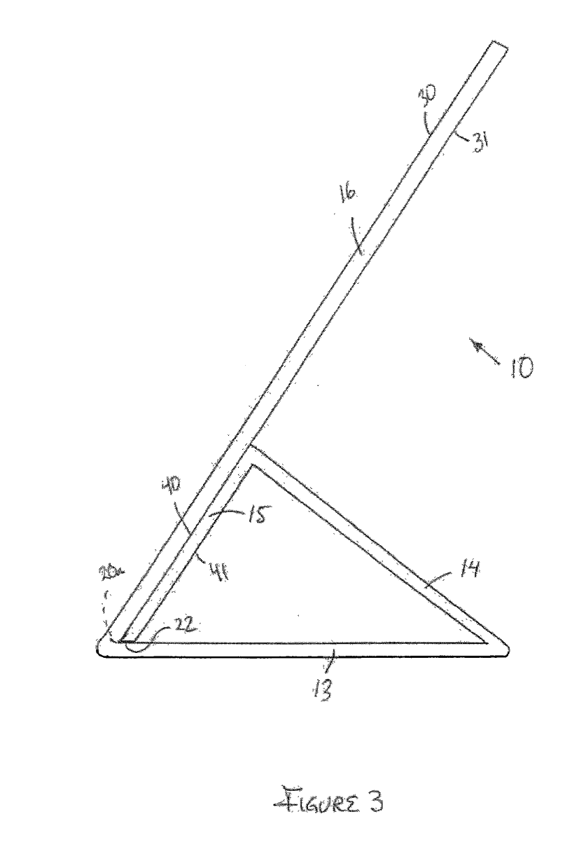

Referring now also to FIG. 3, the display section 16 comprises a front face 30 and a back face 31. The third panel section 15 comprises a first face 40 and a second face 41. In the folded configuration, the first face 40 can be essentially parallel to and at least part thereof can abut the back face 31. When folded into an easel, edge 22 of panel section 15 can be adjacent to the boundary 20a. On the back face 31 of the sheet 12, a greeting 23 can be printed generally within an area 24 as shown in FIG. 2. The sizes of the greeting 23 and the area 24 will be chosen depending on the application. The greeting 23 is visible on the opposite side from the photo 17 when the easel is in its assembled state. Instructions 25 for assembling the article 10 into an easel can be printed generally within an area 26 of the second easel portion 14. Optionally, the instructions can be disposed on at least one of the other easel sections or a suitable portion of the display section. A person assembling the easel can refer to the instructions 25 while assembling the easel, and after the easel is assembled, the instructions are no longer visible. The instructions 25 and the area 26 can have any suitable size and can be printed on any panel section. Also, a manufacturer's name 27 can be printed within an area 28 on the second panel section 14, as shown in FIG. 1. The sizes of the manufacturer's name 27 and the area 28 are chosen depending on the application. When the article 10 is assembled into an easel, the manufacturer's name 27 is displayed toward the back of the easel. In this configuration, the manufacturer's name 27 and front face 30 are on the same side of sheet 12.

Area 26 may be modified, resized, and/or relocated to accommodate an address. In a preferred embodiment, an address section spans section 13, 14, and 15 and an additional adhesive strip with release film is disposed on the reverse side. After the addressee's information is written in the address area, the display element is folded along line 20a and sealed with the adhesive strip to protect the photograph or other displayed element during handling and shipment by the postal service. Optionally, die-cut flaps and tabs or other known means can be used to secure the display element 10 in a folded condition during mailing.

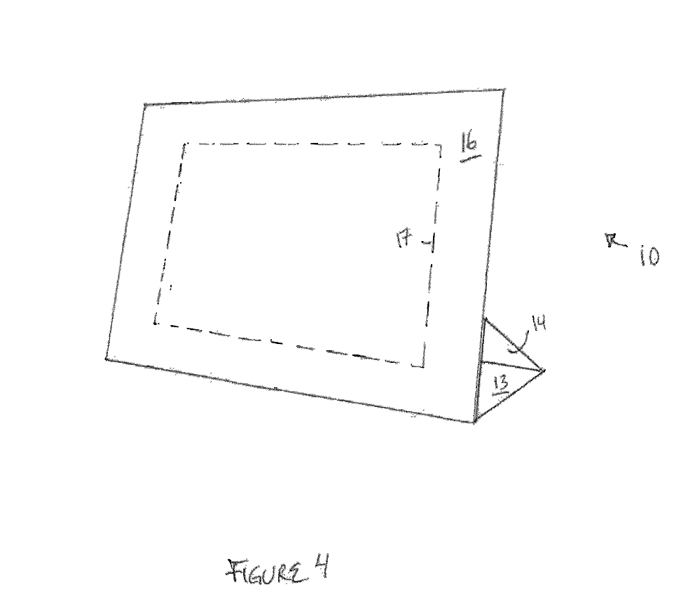

FIG. 4 shows the article 10 assembled as an easel. The easel can display a photograph 17 on display section 16. The display section 16 is held in an upright position by the first, second and third panel sections 13-15 as has been described above. The easel can rest on the first panel section 13. By selecting the proportions of first, second and third panel sections 13-15, the display section 16 can be positioned with an inclination suitable for the particular application. The greeting 23 is visible from the rear of the easel. If a manufacturer's name 27 has been printed on the second panel section 14, it can be visibly displayed toward the rear of the easel in this configuration. However, any instructions 25 for assembling the easel will be substantially hidden from view inside the volume defined by the three panel sections 13-15.

As shown in FIG. 1, the third panel section 15 can comprise a fastener 19 to facilitate the assembly of sheet 12 into an easel. The fastener 19 can be the same as, or different from, the fasteners 18. The shape and strength of the fastener 19 will be chosen depending on the particular application. The fastener 19 can comprise an adhesive covered with a removable cover, such as a protective tape. In this configuration, the fasteners 18 and 19 are on the same side of the sheet 12, and consequently can be formed in a single step. If the fastener 19 is such as to releasably attach the third panel section 15 to the back surface 31 of display section 16, the easel can be disassembled from the configuration shown in FIG. 4. The disassembled easel can attain substantially the configuration of article 10 as described with regard to FIGS. 1 and 2.

The configuration of display element 10 can be modified extensively to accommodate the parameters of various applications. Several examples of contemplated modifications have been mentioned hereinabove. Further examples involve the number, shape and relative dimensions of the panel sections. Any number of panels can be advantageously employed to form a stand or easel. The panel sections need not be rectangular; rather, triangular, trapezoidal, or otherwise shaped panel sections can cooperate with one another in a folding operation to support display element 10. The panels need not be dimensioned in a symmetric or parallel manner; rather, each panel can be provided with unique dimensions. Moreover, the easel portion can be configured so as to support the display area in an completely vertical, horizontal or other orientation; the ease need not maintain the displayed element in a tilted condition. In lieu of folding panel sections, die-cut tabs and slots or other known means may be used to cooperatively support the display area in a desired position. Further, portions of the sheet 12 can be configured to support the display area in a manner not typically associated with a conventional easel. For instance, panel sections 13, 14, 15 can be replaced with die and score cut portions that cooperate when in a folded condition to serve as individual legs or a platform for the display element 10. Separately, an edge of the display portion can be die cut with an arcuate or other non-linear pattern. Such patterns may be used, for instance, to alter the dimensions of the display area, reduce manufacturing and material costs in die-cut operations, or provide a suitably defined label area in which an appropriate character set can be printed. The principles explained above can be readily applied to construct a modified display element having one or more of the features or functionalities described herein.

In various of the described embodiments, display element 10 affords numerous significant advantages. For instance, in an illustrative embodiment, the display element can be readily transformed into a mailable article without the addition of any auxiliary components or adhesives. Rather, all that a user need do is write the delivery address in the appropriate area, remove an adhesive seal strip, and fold the display element. In other illustrative embodiments, display element 10 affords the significant benefit that the easel can be quickly and easily formed without deliberate alignment of the panel sections, adhesive sections, or any edge or border of the display element. Rather, all that is necessary to erect the easel is to remove the protective film from an adhesive strip, fold the panel twice along preformed score lines, and press the folded structure onto the rear face of the display element. Proper alignment of the easel relative to the display area is, in a sense, automatic. This helps avoids misalignment of the easel, which could render display element useless.

A number of embodiments of the invention have been described. Nevertheless, it will be understood that various modifications can be made without departing from the spirit and scope of the invention. Accordingly, other embodiments are within the scope of the following claims.

What is claimed is:

1. An easel for displaying a photograph, comprising:
a sheet having first and second opposing faces and at least one peripheral edge;
said sheet including a display panel portion and an adjacently disposed foldable panel portion;
said display panel portion including means for securing a photograph on said first face of the display panel;
said foldable panel portion including at least three adjacently situated foldable sections, one of said foldable sections terminating at a peripheral edge of the sheet, wherein the sections are cooperatively configured to form an easel wherein the first face of the last foldable section abuts the second face of the display panel; and
an address area disposed on said second face of the sheet, said address area being defined by at least one indicium spaced apart from a peripheral edge of said sheet;
whereby the foldable portion can be folded in a first manner to support the display panel and in a second manner to cover the photograph.

2. A display element comprising:
a sheet having first and second opposing faces and at least one peripheral edge;
said sheet including a display panel portion and an adjacently disposed foldable panel portion;
said display panel portion including means for securing an article on said first face of the display panel;
said foldable panel portion including a plurality of discrete foldable sections cooperatively configured to form an easel that contacts the second face of the display panel; and
an address area disposed on said second face of the sheet, said address area being defined by at least one indicium spaced apart from a peripheral edge of said sheet.

3. The display element of claim 2, wherein the foldable sections are adjacently situated panels.

4. The display element of claim 3, wherein the foldable sections are defined by parallel score lines.

5. The display element of claim 4, comprising three or more foldable sections.

6. The display element of claim 2, wherein the area of the foldable panel is substantially the same as the display panel.

7. The display element of claim 2, wherein the securing means is a adhesive with a releasable protective strip.

8. The display element of claim 2, further comprising a means for securing a foldable portion to the second face of said display panel.

9. The display element of claim 2, further comprising means for securing a distal edge of the foldable panel to a distal edge of the display panel.

10. The display element of claim 2, wherein the sheet is substantially planar and includes at least one arcuate edge.

11. The display element of claim 2, wherein the address area is defined by a plurality of substantially linear borders spaced inwardly from the peripheral edges of the sheet.

12. A display element comprising:
a sheet having first and second opposing faces and at least one peripheral edge;
said sheet including a display panel portion and an adjacently disposed foldable panel portion;
said display panel portion including means for securing an article on said first face of the display panel;
said foldable panel portion including at least three adjacently situated foldable sections cooperatively configured to form an easel wherein the first face of a foldable section abuts the second face of the display panel.

13. The display element of claim 12, further comprising an address area disposed on said second face of the sheet, said address area being defined by at least one indicium spaced apart from a peripheral edge of said sheet.

14. The display element of claim 12, wherein the area of the foldable panel is substantially the same as the display panel.

15. The display element of claim 12, wherein the securing means is a adhesive with a releasable protective strip.

16. The display element of claim 12, further comprising a means for securing a foldable portion to the second face of said display panel.

17. The display element of claim 12, further comprising means for securing a distal edge of the foldable panel to a distal edge of the display panel.

18. The display element of claim 12, wherein the sheet is substantially planar and includes at least one arcuate edge.

19. The display element of claim 13, wherein the address area is defined by a plurality of substantially linear borders spaced inwardly from the peripheral edges of the sheet.

20. A display element comprising:
a sheet having first and second opposing faces and at least one peripheral edge;
said sheet including a display panel portion and an adjacently disposed foldable panel portion;
said display panel portion including means for securing an article on said first face of the display panel;
said foldable panel portion including at least three adjacently situated foldable sections cooperatively configured to form an easel wherein the a terminal edge of a foldable section abuts a folded joint between the display panel and said foldable panel.

21. The display element of claim 20, further comprising an address area disposed on said second face of the sheet, said address area being defined by at least one indicium spaced apart from a peripheral edge of said sheet.

22. The display element of claim 20, wherein the area of the foldable panel is substantially the same as the display panel.

23. The display element of claim 20, wherein the securing means is a adhesive with a releasable protective strip.

24. The display element of claim 20, further comprising a means for securing a foldable portion to the second face of said display panel.

25. The display element of claim 20, further comprising means for securing a distal edge of the foldable panel to a distal edge of the display panel.

26. The display element of claim 20, wherein the sheet is substantially planar and includes at least one arcuate edge.

27. The display element of claim 21, wherein the address area is defined by a plurality of substantially linear borders spaced inwardly from the peripheral edges of the sheet.
